(19) United States
(12) Patent Application Publication
(10) Pub. No.: US 2011/0006782 A1
(43) Pub. Date: Jan. 13, 2011

(54) INSULATION MONITORING OF SERVICING UNITS USED IN A POTROOM FOR THE PRODUCTION OF ALUMINUM BY IGNEOUS ELECTROLYSIS

(75) Inventors: Patrick Marchand, Lesquin (FR); Didier L'Heureux, Ronchin (FR)

Correspondence Address: BANNER & WITCOFF, LTD., TEN SOUTH WACKER DRIVE, SUITE 3000, CHICAGO, IL, 60606, US

(73) Assignee: E.C.L., Ronchin (FR)

(21) Appl. No.: 12/919,300

(22) PCT Filed: Feb. 20, 2009
(86) PCT No.: PCT/FR09/00190

§ 371 Date: Aug. 25, 2010

(30) Foreign Application Priority Data
Feb. 25, 2008 (FR) 08 01004

(51) Int. Cl. H01H 31/12

(52) U.S. Cl. 324/551

(57) ABSTRACT

A system permanently monitoring the insulation of a frame from its neighbors, comprising:
a) an IMD (100);
b)) a first portion of measuring circuit (103) connecting said frame (70) to a first terminal of said IMD;
c) a second portion (104, 201, 108, 109) of measuring circuit used to connect the second terminal (102) of said IMD to each of said adjacent frames (80, 90), said second portion of measuring circuit including at least one relay (201) that makes it possible to connect said IMD alternately to a portion (104, 201, 108; 104, 201, 109 respectively) of measuring circuit connected to said adjacent frame (80, 90 respectively);
   Said IMD injects alternately, on each switching, a current into the measuring circuit in order to measure the resistance of said circuit.

Said system is used to regularly monitor the insulation of the various parts of a servicing unit designed for work on an electrolytic cell, the measuring circuits being designed preferably so that only a single IMD is used. This system may also include a regular monitoring system for the power circuits.

The invention relates to service machines and other servicing units, which are used in factories for producing aluminum by igneous electrolysis and which require the use of an overhead traveling crane. It more particularly relates to monitoring the structure and power insulation of these devices.

Aluminum is produced industrially by igneous electrolysis, namely by electrolysis of alumina in solution in a molten cryolite bath, known as an electrolytic bath, using the well-known Hall-Héroult process. The electrolytic bath is contained in tanks, called “electrolytic pots”, comprising a steel container, which is coated on the inside with refractory and/or insulating materials, and a cathodic unit located at the bottom of the pot. Anodes made of carbonaceous material, are partially immersed in the electrolytic bath. The assembly formed by an electrolytic pot, its anodes and the electrolytic bath is called an electrolytic cell.

The plants contain a great number of electrolysis cells laid out in line, in buildings called potrooms, and electrically connected in series using connecting conductors, in order to make the best use of the floor area of the plants. The cells are generally laid out so as to form two or more parallel lines which are electrically linked to each other by end conductors. The electrolysis current thus cascades from one cell to the next.

When operating, an electrolysis plant requires work on the electrolysis cells, including replacement of spent anodes by new ones, sampling of molten metal from the cells and sampling or top-ups of electrolyte. In order to carry out this work, the most modern factories are equipped with one or more service units including an overhead traveling crane which can be moved above the electrolytic cells, and along these, a service module including at least one carriage able to be moved on the overhead traveling crane on which are fixed handling and servicing devices (often called “tools”)—such as hoists, shovels, tappers, etc—or, possibly, even a control cabin. These service units are often called “Pot Tending Assemblies” (PTA) or “Pot Tending Machines” (PTM). There exist other devices for working on an electrolytic cell which are also interdependent of an overhead traveling crane, for example lifting beams for pot handling, also called Cathode Transport Assemblies (CTA) such as that described in patent FR 2.862.663 by the applicant. Still other devices, such as the beams for raising the anode frame, for example that illustrated in patent FR 1 445 602, can be suspended from an overhead traveling crane. Hereafter, PTAs, CTAs, overhead traveling cranes equipped with anode frame lifting beams or other devices for working on the cell requiring the use of an overhead traveling crane will be referred to under the general term “servicing unit”.

During this work, certain tools have to go down into the electrolytic bath, to handle anodes and/or to move near the positive risers. By accident or design, these tools come into contact with elements that are charged with an electric potential different from that of the earth. It is therefore important that maintenance staff working in the control cabin and the on-board equipment, in particular all the pumps, motors and electrically-operated valves (hereafter referred to as “receivers”) used to actuate the overhead traveling crane, carriage and suspended devices, be electrically insulated. Typically, in the majority of installations, a current of several hundreds of thousands of amperes passes through the pots, with a voltage between anodes and cathode in the area of 4 volts. But, as the pots are connected to each other electrically in series, the operator may be subjected, in the event of a failure in the insulation of the structures and in very special circumstances, to very high over-voltages, of up to approximately 1500 volts, or even more, according to the row of the cell on which the work is being carried out.

It is recommended that the service unit made up of the overhead traveling crane, earthed via the gantry track, the carriage and the devices for working on the electrolytic cell, be subdivided into different frames and that these be insulated using separate systems. A PTA is therefore usually subdivided into at least four insulated parts: the overhead traveling crane, the carriage and the tool-holder turret, the set of tools and finally the control cabin. Each of these zones, and in particular the set of tools, can itself be subdivided into frames that are separate and insulated from each other. “Frame” is taken here to mean a conducting part likely to be touched, which is not normally a live part but which may become so in the event of a fault. Several configurations are possible, for example the cabin is fixed either to the carriage, or the turret. But it is important to comply with the rule according to which any tool that may come into contact with the electrolysis bath (either directly, or via the anode or the cathode) as well as the cabin, in which there is likely to be staff, must be separated from the earth by at least two insulator levels: in the event an insulation failure on one frame, the equipment or operator is protected by the non-defective insulation of the other frame. However it is important that the fault be quickly located and repaired.

Between two adjacent frames, structural insulators have been fitted, placed at the mechanical interfaces (structure insulation). As an interface between two frames may include several insulators, in the following the term “insulator level” will refer to all these structure insulators in conjunction with an interface between two frames. By means of a plurality of separation transformers, it has been possible to transmit electrical power at the level of each frame onto an isolated circuit supplying the receivers associated with said frame, for example electric motors, jack pumps, electrically-operated valves, etc (power insulation). A test of the power insulation at the level of each frame and a test of the insulation of a frame from its neighbor were initially performed, in particular during maintenance operations. But these were specific tests and it becomes necessary to carry out regular monitoring of these two types of insulation throughout the life of the servicing unit. However, until the present invention, we have not found any method or device providing reliable, permanent and systematic monitoring of both power insulation and structure insulation for servicing units such as PTAs or CTAs.

With regard to power circuits, the system earthing should, for reasons of service continuity, be an IT (impedance-earthed neutral) system earthing. In this type of system earthing, the neutral is deliberately earthed by a high impedance (typically several thousands of ohms) and the frames are normally inter-connected. Upon the first fault, there is no danger to people, but it is necessary to remove this fault before a second fault appears which would cause a short-circuit current between two phases.

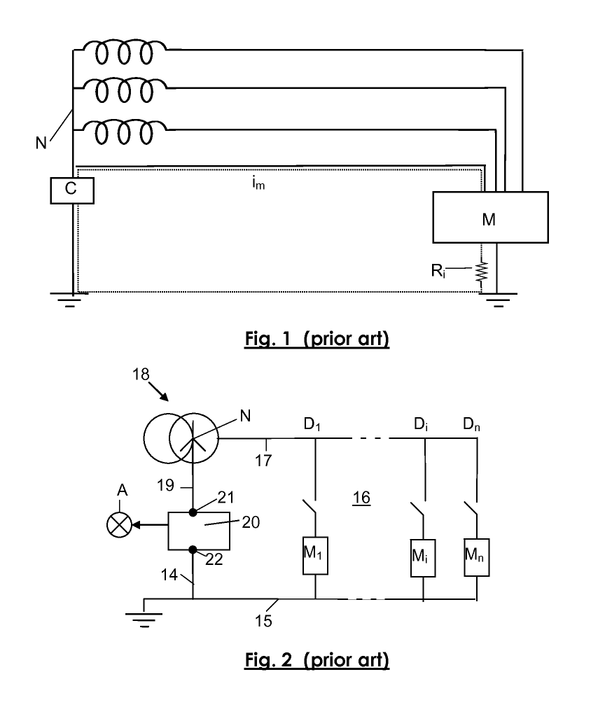

Permanent insulation monitoring devices (IMD) are also known: these are electronic devices that can detect a fault on installations of the impedance-earthed neutral network type, frequent in industry or hospitals: IMDs are used to cut off the electricity supply only in the event of a second fault on the installation, which allows the maintenance department to repair the first fault without any loss of productivity or interruption of treatment. FIG. 1 illustrates the operating principle of an IMD: the latter (C) is connected to an earthed receiver (here a motor M supplied with three-phase current). This IMD monitors the insulation of the power circuit from the earth: by injecting a measurement current (iₘ) into the loop formed by the active conductors and the earth (shown by a circuit in dotted lines in FIG. 1), it measures the insulation resistance Rᵢ. When, for the first time, the equivalent insulation resistance Rᵢ measured is below a certain threshold, the IMD indicates the appearance of the first fault, sends an alarm and this first fault must be dealt with before a second fault appears, upon which the current is systematically shut off by means of short-circuit protection safety devices (SCPD).

The previous schematic diagram has been transposed into FIG. 2 to represent the power insulation monitoring through an IT system earthing. The IMD (20) is connected between the neutral point (NR) of the separation transformer (18) and the earth. The neutral, not distributed, is not insulated but impedance-earthed, because of the high impedance (greater than 1 kΩ) of the IMD. The installation is completed by an alarm (A) Each outgoing power cable (D₁, . . . , Dᵢ, . . . , Dₙ) make it possible to power at least one receiver (M₁, . . . , Mᵢ, . . . , Mₙ), each receiver itself being earthed. The IMD measures the total insulation of the installation from the earth. The IMD is therefore connected to a loop which is made up of:
a first electrical connection means (19), typically a conductor, which connects a terminal (21) of the IMD (20) to the neutral (N) of the transformer (18);
the power supply device (17), typically two conductors (two-phase current) or three conductors (three-phase current);
the set (16) of receivers (M₁, . . . , Mᵢ, . . . , Mₙ) and their connecting devices to the outgoing power cables (D₁, . . . , Dᵢ, . . . , Dₙ);
the device (15) for connecting the receivers to the earth (typically a plurality of conductors);
the earth itself which is connected to the other terminal (22) of the IMD (20) by a second electrical connection means (14).

However, within the specific framework of servicing units used to work on an electrolytic cell, we have frames which, like the cabin or the tools, must be separated from the earth by at least two insulator levels, so that the conventional operating scheme of an IMD cannot be followed. If the latter is connected between two frames, the risk of a double fault which it was desired to avoid may appear as of the first fault on the insulator level between these two frames, if another insulator level has additionally already been the site of an initial fault. The break conventionally ensured by the short-circuit protection safety devices (SCPD) when a second fault appears on an insulator level is not here a sufficient guarantee against the appearance of electric shocks, or even of electrocution, since a full fault on an insulator level and a full fault on another insulator level do not give rise to an automatic break. Moreover, the specific industrial context of aluminum electrolysis means that it is not possible to allow a break in power, so that it is essential to avoid the appearance of a second fault, whether this is indeed the second fault on the same insulator level or the first fault on another insulator level.

In addition, known IMD devices generally operate with voltages lower than 600V approximately. High voltage plates (HVP), also called high voltage adapter plates, coupling plates or voltage adapter plates, are proposed in conjunction with an IMD device when the latter is intended to operate in an environment in which voltages may reach several thousands of volts. These HVPs comprise an electrical circuit placed between the IMD and the loop to be tested, the circuit being designed so as to limit the voltage between the IMD terminals to a value compatible with proper performance.

The applicant sought to develop a system which makes it possible to ensure reliable, permanent and systematic monitoring of the power insulation and also the structure insulation on the service units of an electrolytic cell; said system must additionally not have any risk of a double fault. Moreover, with regard to the structure insulation, the control system must be able to withstand current of up to 2000 volts

A first object according to the invention is a monitoring system for regularly monitoring the insulation of a frame which is separated from a plurality of adjacent frames and is isolated from each of said adjacent frames by an insulator level, characterized in that it comprises:

a) a permanent insulation monitoring device (IMD), preferably connected to an alarm system;
b) a first portion of measuring circuit connecting said frame, which will be referred to hereafter as “first frame”, to a first terminal of said IMD;
c) a second portion of measuring circuit used to connect the second terminal of said IMD to each of said adjacent frames, said second portion of measuring circuit including at least one relay that can be switched, typically mechanically or electromagnetically, in order to alternately connect electrically said IMD to a measuring circuit portion connected to each of said adjacent frames; said IMD being provided with a means used to inject a current into the measuring circuit formed by the switching of said relay and to measure the resistance of said circuit.

The system according to the invention makes it possible to systematically monitor, by means of switching at least one relay, the insulation of alternate given frames from their neighboring frames. It can do this reliably by using a single IMD, used alternately to measure the insulation resistance between the frame to be checked and each of its adjacent frames; in other words to check that there is no fault on each insulator level associated with said frame. The point of using a single IMD is that it provides better measurement reliability, because an IMD installed in the vicinity of another IMD, and operating at the same time as the latter, generates sufficiently strong disturbances to influence the results of the measurement carried out by this latter IMD.

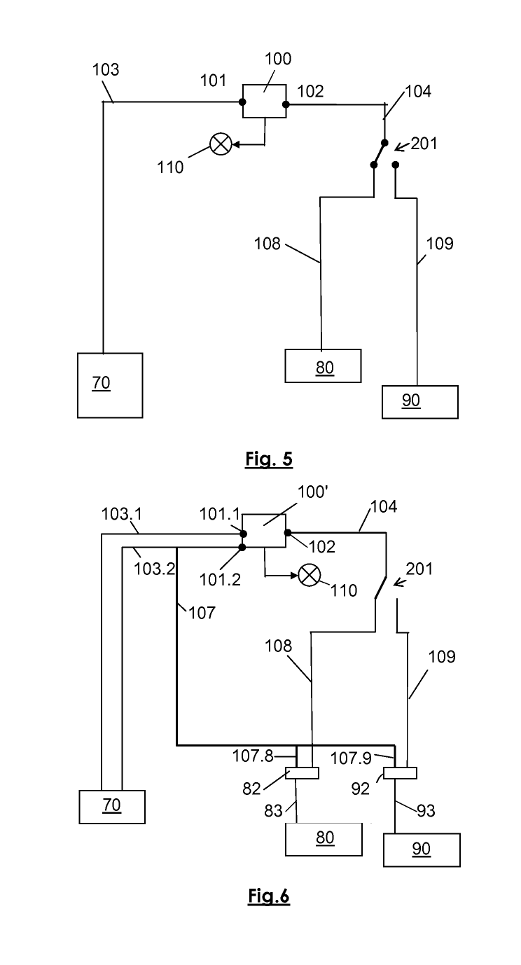

FIG. 5 illustrates a permanent monitoring system for the structure insulation of a frame (70) as compared with its two adjacent frames ((80) and (90)). It comprises, to monitor the structure insulation of the frame (70):

a) a permanent insulation monitoring device (IMD) (100), advantageously connected to an alarm system (110);
b) a first portion of measuring circuit (103) connecting said frame to a terminal (101) of said permanent insulation monitoring device;
c) a second portion of measuring circuit (104, 201,108,109) making it possible to connect the other terminal (102) of said permanent insulation monitoring device to each frame (80, 90) adjacent to said frame, said second portion including at least one relay (201), typically actuated mechanically or electromagnetically, which makes it possible to alternately connect electrically said permanent insulation monitoring device to a measuring circuit portion (108, 109 respectively) connected to said adjacent frame (80, 90 respectively).

The IMD is connected to the frame (70) whose insulation is to be monitored, via the conductor (103), one end of which is connected to the frame (70). It is connected, via the conductor (104), and alternately via the relay (201), to the neighboring frame (80), via the conductor (108), one end of which is connected to the frame (80) or to the neighboring frame (90), via the conductor (109), one end of which is connected to frame (90). Said IMD is provided with a means used to inject a current into the measuring circuit formed by the switching of said relay(s) and with a means to measure the resistance of the circuit formed in this way. Typically the means used to inject a current is a micro-controller in conjunction with a current generator. Preferably, it emits electrical signals with a coded frequency, typically a measurement pulse made up of positive and negative pulses of the same amplitude.

The relays used are typically mechanically-actuated devices or, preferably, electromagnetically-actuated to switch from one portion of the measuring circuit to the other. Advantageously, synchronization between switching the relay and injecting the measurement current into the new circuit is managed by a controller, preferably a programmable controller.

For the measurement result to be reliable, it is necessary to be sure that the indication of an infinite insulation resistance is well and truly the consequence of a perfect insulation and not that of a break in the measurement cable. To avoid such a mishap, it is recommended to duplicate the cables of the measuring circuit. In a preferred method of the invention, a IMD is used which has at least one of its terminals duplicated as two studs and which is provided with a system making it possible to test the intactness of a loop connected both to a stud of said duplicated terminal and either to the other stud of said terminal, or to the other terminal: if a signal sent to one end of the loop is not received at the other end of said loop, it may be concluded from this that one of the cables of the loop is damaged and the IMD sends an alarm so that it can be repaired or replaced.

In a preferred method of the invention, the first terminal, duplicated as two studs, is connected to the first portion of the circuit, which includes two cables connecting said IMD to the frame whose insulation from its neighbors is to be monitored, and the second portion of the measuring circuit, which makes it possible to connect said IMD to each adjacent frame, is itself duplicated, the second electrical connection not necessarily going through the relay and connecting all the frames adjacent to one of the studs of the duplicated IMD terminal.

In the context of controlling the structure insulation of frames belonging to a servicing unit used to work on a electrolytic cell, the IMD used is likely to have to operate with very high voltages, exceeding 600 V. Advantageously the IMD used has an impedance typically higher than 1 MΩ, defined so that, even with an over-voltage of 2000 V between two frames, the current likely to pass through a human being coming into contact with these two frames simultaneously remains lower than a critical value, typically corresponding to the sensitization or even tetanization current such as defined in a safety standard, for example standard CEI 60479. Moreover, the relays used are preferably high voltage relays which, by definition, can withstand voltages higher than 1500 V. It is also recommended to use the IMD in conjunction with at least one voltage adapter plate (HVP).

FIG. 6 illustrates a particular monitoring system of the invention combining an IMD with a high level of impedance, additionally provided with a system to test the intactness of the measuring circuits, the duplicated wiring measurement circuits and a plurality of high voltage adapter plates placed on the adjacent frames. This system allows regular monitoring of the structure insulation of a frame (70) separated from each one of its two adjacent frames (80, 90) by an insulator level (indicated by 81 and 91 respectively in FIG. 4). It comprises, to monitor the structure insulation of the frame (70):

a) a permanent insulation monitor (100′) whose impedance is typically higher than 1 MΩ, said IMD having at least one first terminal duplicated as two studs (101.1 and 101.2) and being provided with a system for testing the intactness of a loop connected to a stud (101.2) of said duplicated terminal and to either the other stud (101.1) of said terminal, or to the other terminal (102), said IMD being advantageously connected to an alarm system (110);
b) a first portion of the double measuring circuit (103.1, 103.2) connecting said frame to the studs (101.1) and (101.2) of the first terminal of said IMD, each cable (103.1, 103.2 respectively) of the first portion of the double circuit being connected to one of the studs (101.1, 101.2 respectively) of the first duplicated terminal;
c) a plurality of high voltage adapter plates (82, 92), each high voltage adapter plate being connected to one of said adjacent frames (80, 90);
c) a second portion of the double measuring circuit (104, 201, 108, 109, 107) making it possible to connect the other terminal (102) of said IMD to each of the adjacent frames (80, 90), said second portion including at least one relay (201), typically actuated mechanically or electromagnetically, which makes it possible to alternately connect electrically said IMD to a portion of the measuring circuit (108, 82 and 83, and 109, 92 and 93 respectively) connected to said adjacent frame (80, 90 respectively), said second circuit portion being duplicated by wiring (107, 107.8,107.9) connecting said high voltage plates (82, 92) to a stud (101.2) on said first duplicated terminal, in order to test the intactness of the loop made up by the connection with the voltage adapter plate (104, 201, 108 or 104, 201, 109) of the adjacent frame (80 or 90) corresponding to the insulator level being monitored (81 or 91) and by said wiring (107.8 and 107, or 107.9 and 107).

It should be noticed that in this diagram the intactness of the connections (83) and (93) between the frames (80) and (90) and voltage adapter plates (82) and (92) is not checked: preferably, said voltage adapter plates are installed on the frames with which they are associated so that one of their terminals is directly connected electrically to said frames. Typically, said voltage adapter plates are connected by bolting onto the ground bars of the frames with which they are associated.

For each frame, the insulation measurement must be made in established operating conditions but the time taken to reach the established conditions is not known in advance. The time necessary for a “good measurement” made by an IMD depends on R&C (resistance and capacity) conditions at the terminals of its measurement circuit and these parameters vary randomly. One solution is to define a fixed response time, which penalizes the frequency of tests and/or does not ensure that the insulation measurement is correct. A second solution is to control the relays using a controller which takes into account a signal emitted by the IMD indicating that the measurement made has been validated, that overall the measurement is finished and that one can switch over to the next measuring circuit. This can be achieved by injecting coded signals, repeated several times in the measuring circuit, and analyzing the signals received: the repetition of a coherent received signal is the sign that established operating conditions have been reached and that the measurement is coherent. Measurement on the following circuit may then proceed. The IMD can be arranged so that it emits a signal indicating that, the measurement made having been validated and finished, one or more switches can be turned to make the next measuring circuit. Relay(s) can be switched using a programmable controller reacting to the signal emitted by the IMD. In this way, an intelligent management system is obtained, which reliably and as quickly as possible measures the quality of the insulation, in spite of the randomness of this type of measurement.

Another object of the invention is a monitoring system for regularly monitoring the insulation of a servicing unit used for working on a electrolytic cell, said servicing unit being subdivided into frames separate from each other by insulator levels, any frame likely to come into contact with the electrolysis bath or to accommodate staff having to be separated from the earth by at least two insulator levels, characterized in that it comprises a set of elementary monitoring systems for regularly monitoring insulation such as that described previously, each frame making up said servicing unit being used either as a first frame, or as adjacent frame in at least one of said elementary regular monitoring systems.

Therefore, for certain frames of the servicing unit which have at least two adjacent frames, can be found a system which includes:

a) a permanent insulation monitoring device (IMD), preferably connected to an alarm system;
b)) a first portion of measuring circuit connecting said frame, called “first frame”, to a first terminal of said IMD;
c) a second portion of measuring circuit making it possible to connect the second terminal of said IMD to each frame adjacent to said first frame, said second portion including at least one relay which makes it possible to alternately connect electrically said IMD to a portion of the measuring circuit connected to each of said adjacent frames, said IMD injecting alternately, each time said relay is switched, a current into the measuring circuit formed in this way, in order to measure the resistance of said circuit.

Said monitoring system for regularly monitoring the insulation of a servicing unit makes it possible to monitor the structure insulation on all the frames of a servicing unit, even though it may comprise elementary monitoring systems which are not applied to all the frames. The elementary monitoring system for monitoring the structure insulation is applied only to frames having at least two adjacent frames. In particular, there is no need to use a specific structure insulation monitoring system for the peripheral frames because these are connected only to one other frame and this other frame, having at least two neighboring frames, must in addition undergo an elementary insulation monitoring, as described previously, during which the quality of the insulator level which separates it from said peripheral frame is tested.

Obviously, said elementary structure insulation monitoring systems may include one or more additional characteristics described above, in particular:
synchronization between switching the relay(s) and injecting the measurement current into the measurement circuit, managed by a controller, preferably a programmable controller,
the first and second portions of the measuring circuit duplicated,
an IMD with an impedance greater than 1 MΩ,
at least one high voltage relay,
high voltage adapter plates.

All the frames with at least two neighboring frames are not inevitably associated with an elementary regular structure insulation monitoring system, because this would involve many redundant controls. If the insulation of a frame A from a frame B has already been checked, there is no point in checking the insulation of frame B from frame A since it is the quality of the same insulator level which is being monitored. In other words, it is not necessary for all frames with at least two neighboring frames separated by insulator levels to be monitored as a “first frame” if the intactness of the insulator level has already been checked while said frame was being used as an adjacent frame of the other frame on which a test has been carried out beforehand. It is therefore necessary to define a scenario which takes account of the respective positions of the frames in relation to each other and then to make a set of measuring circuits adapted to this scenario.

Preferably, the IMD is unique not only for the set of measurements relating to the insulation of a frame from its neighbors but also for all the structure insulation measurements which are to be made on all the frames that make up the service unit. To achieve this, said first portions of the measuring circuit and said second portions of the measuring circuit are arranged so that only one IMD is used to carry out all the insulation measurements. Here too, as indicated previously, the design of the measuring circuits used to monitor, using a single IMD, the structure insulation of all the frames that make up a service unit is highly dependent on the choice of the layout of the various frames of the service unit. The layout of these circuits depends in particular on the type of relay chosen (single switch or multiple switch relay). If, as in the following example, single switch relays are chosen, they must be installed in cascade, starting from a particular frame acting as a “pivot”.

Advantageously, instead of installing only one voltage adapter plate (HVP) near the IMD, an HVP is installed on each frame which, in the chosen monitoring scenario, must be used as an adjacent frame to a first frame. For example, said high voltage adapter plate is installed on the portion of circuit pertaining to the second portion of the measuring circuit and connected to said adjacent frame. However, if one of these adjacent frames is used thereafter as a first frame, it must be connected to an IMD via a first circuit, without the intermediary of a voltage adapter plate. In the following example, illustrated in FIG. 9, can be seen a frame (70) which is connected to the IMD by a first duplicated portion of circuit (103.1 and 103.2) which is not connected to a high voltage adapter plate and which is used when the frame (70) is used as a first frame, and also by a second portion of circuit connected to a high voltage adapter plate (72) and which is used when the frame (70) is used as a frame adjacent to the frame (60).

Advantageously, the system according to the invention is completed by a system making it possible to regularly monitor the insulation of the power circuits, at the level of each frame of the service unit. In general, a different IMD from that used to monitor the to structure insulation is used. Preferably, the measuring circuits are arranged so that only one IMD is used to carry out regular monitoring of the power insulation at the level of each frame. To do this, said measuring circuits advantageously include relays that can be switched to monitor the power insulation at the level of each frame alternately.

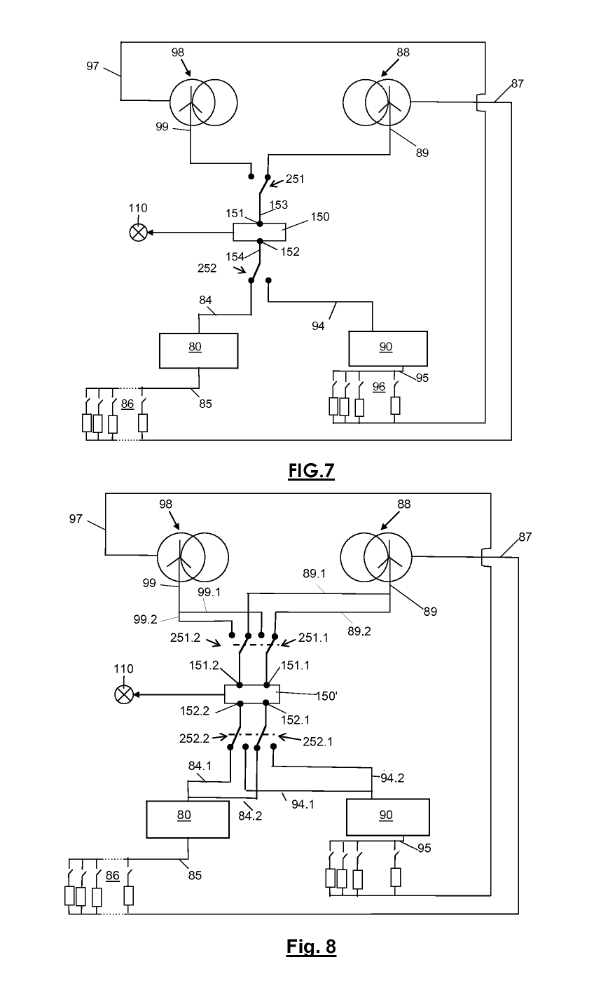

FIG. 7 illustrates a system which makes it possible to systematically monitor the insulation of the power circuits on two frames (80) and (90). The separation transformer (88, 98 respectively) makes it possible to transmit electric power (87, 97 respectively) to a set (86, 96 respectively) of receivers. The IMD (150), different from the IMD used to check the structure insulation, is connected between the neutral point (N) of the separation transformer (88, 98 respectively) and the frame associated with the power circuit being monitored. In the context of servicing devices for electrolytic cells, to ensure both insulation of the frames and continuity of service, an IT system earthing was adopted, the neutral being connected to the frame by a high impedance. The neutral is impedance-earthed, because of the high impedance (greater than a 1 kΩ) of the IMD. The installation is completed by an alarm (110). The separation transformer (88, 98 respectively) powers, via the power supply system (87, 97 respectively), the set of receivers (86, 96 respectively) associated with a frame (80, 90 respectively). The receivers are connected to the frame (80, respectively 90) by means of a frame connection device (85, 95 respectively). A double relay (251, 252) with synchronized switching is used to connect the IMD (150) to the neutral of the transformer (88, respectively 98) via a first portion of circuit (153, 251 and 89; 153,251 and 99 respectively) and in addition to said frame (80, 90 respectively) by means of a second portion of circuit (154, 252 and 84; 154,252 and 94 respectively).

In this way with only one IMD, the power circuit insulation of two frames can be monitored. The diagram in FIG. 7 can be transposed to power insulation monitoring of all the frames: to monitor the power circuit insulation of each of the frames of the service unit with the same IMD, each frame having a separation transformer supplying, via a power supply device, all the receivers associated with said frame, said receivers being connected to said frame, said IMD is connected, alternately via suitable relays, for example two relays with synchronized multiple switching, to the neutral of the transformer associated with said frame by means of a first portion of circuit including one of said relays, and also to said frame by means of a second portion of circuit including the other of said relays.

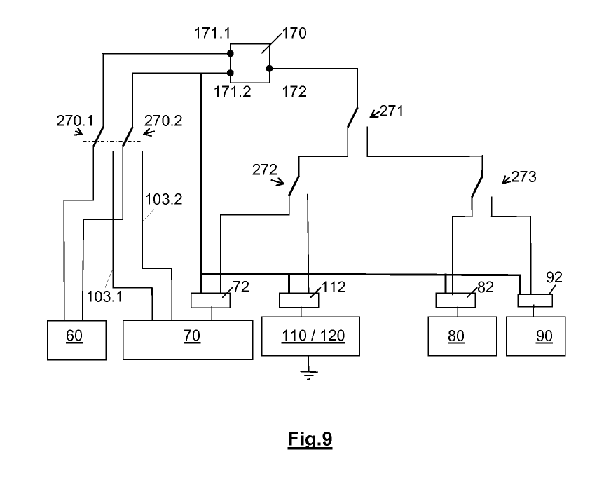

Here too, the intactness of the measurement wiring can be ensured by duplicating said wiring. FIG. 8 shows an alternative to the system illustrated in FIG. 7, in which the wiring of the measuring circuits is duplicated. The IMD used here has two duplicated terminals (151.1 and 151.2, 152.1 and 152.2). The connecting cables of the IMD to the frames are duplicated (84.1 and 84.2; 94.1 and 94.2 respectively). Similarly, the connecting cables from the IMD to the neutrals of the transformers (88, 98 respectively) are duplicated (89.1 and 89.2; 99.1 and 99.2 respectively). There are two synchronized pairs of coupled switch relays (251.1 and 251.2; 252.1 and 252.2).

Another object of the invention is a process for monitoring the insulation of a frame which is separated from a plurality of adjacent frames and which is isolated from each of said adjacent frames by an insulator level, characterized in that a regular insulation monitoring system as described previously is used for monitoring the insulation of a frame from its neighbors.

Another object of the invention is a process for monitoring the insulation of a servicing unit used in a potroom for the production of aluminum by igneous electrolysis, said servicing unit being subdivided into frames separated from each other by insulator levels, any frame likely to come into contact with the electrolysis bath or to accommodate staff needing to be separated from the earth by at least two insulator levels, characterized in that a regular monitoring system as described previously is used for monitoring the insulation of a servicing unit.

FIG. 1 illustrates the operating principle of a permanent insulation monitoring device for a power circuit.

FIG. 2 illustrates the conventional operating principle of a permanent insulation monitoring device for a power circuit wired according to an IT system earthing.

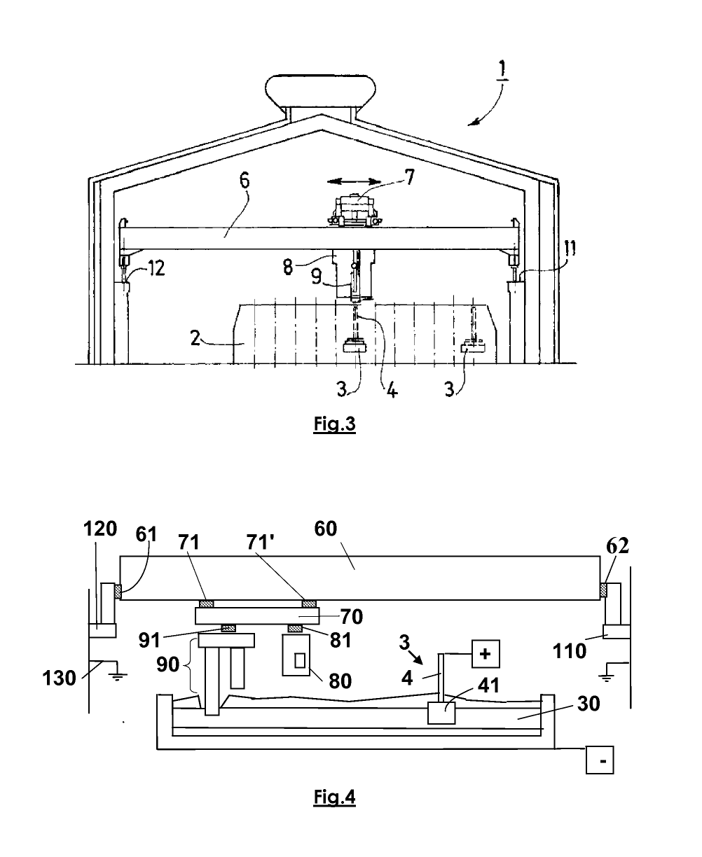

FIG. 3 is a front cross-sectional view of a typical potroom for the production of aluminum.

FIG. 4 schematically illustrates the various levels of frames of a service unit including an overhead traveling crane and a PTA.

FIG. 5 schematically illustrates a device according to the invention that can be used to regularly monitor the insulation of a frame from its adjacent frames.

FIG. 6 schematically illustrates a device similar to the previous one, making it possible to regularly monitor, but with duplication of the measuring circuit, the insulation of a frame from its adjacent frames.

FIG. 7 schematically illustrates a device used to monitor, regularly and with the same IMD, power circuit insulation on two frames.

FIG. 8 shows a device similar to the previous one, making it possible to regularly monitor, but with duplication of the measuring circuit, the insulation of power circuits on two frames.

FIG. 9 schematically illustrates a device according to the invention making it possible to permanently monitor the structure insulation on all the frames of a service unit.

### EXAMPLE OF EMBODIMENT

### FIG. 3, FIG. 4 and FIG. 9

Electrolysis plants for the production of aluminum include a liquid aluminum production area containing one or more potrooms (1). As illustrated in FIG. 3, each potroom (1) has electrolytic cells (2) and at least one lifting and handling unit or “Pot Tending Machine” (5=6+7+8+9). The electrolytic cells (2) are normally laid out in lines or files (typically side-by-side or head to head), each line or file typically comprising a hundred, or several hundred cells. Said cells (2) include a series of anodes (3) provided with a metal stem (4) for fixing the anodes and connecting them electrically to a metal anode frame. The anode stem (4) is typically of substantially rectangular or square section. It is connected to an anodic block (41) which drops into the electrolytic bath (30).

The lifting and handling unit (5) is used to carry out operations on the cells such as changing an anode or filling the electrolytic cell feed hoppers with crushed melt and AIF3. It can be also used to handle various loads, such as pot parts, ladles of molten metal or anodes. Said unit (5) typically includes an overhead traveling crane (6), a carriage (7) able to move on the overhead traveling crane (6), and, fixed to a frame interdependent with said carriage, a cabin (8) for the operator, and handling and servicing devices (called “tools”) such as, a shovel or crust breaker (not illustrated), a tapper (not illustrated) and/or a handling device (9) provided with an anode gripper (10).

The overhead traveling crane (6) rests and circulates on gantry tracks (11, 12) laid out in parallel with each other and with the main—typically longitudinal—axis of the hall (and the line of cells). The overhead traveling crane (6) can thus be moved along the electrolysis hall (1).

In FIG. 4, we have shown a possible subdivision of the previous service unit into frames isolated from each other: the gantry tracks (110) and (120), both earthed, the overhead traveling crane (60), the unit (70) comprising the carriage, its frame which can turn around a vertical axis interdependent of said frame, the cabin (80) and the turret and the tools (90). Each frame is separated from its neighbor by at least one structure insulator (61, 62, 71, 71′, 81, 91). This is only an example, several other configurations being possible: in general, for example, there is no insulator between the overhead traveling crane (60) and the gantry tracks (110) and (120). However, even in the absence of structure insulators (61) and (62), the overhead traveling crane, earthed, must be regarded as a frame separate from the other frames of the servicing unit and isolated from these, by means of the insulator level (71 and 71′). In addition, there may be greater separation of the frames made up by the tools which are in general fitted onto a turret, itself assembled on the frame interdependent of the carriage (70), in particular by insulating each of them from the turret and the other tools. The tools (90) and the cabin (80) are separated from the earth by at least two insulator levels (91 and 71+71′; 81 and 71+71′).

FIG. 9 illustrates a system according to the invention with double wiring of the measuring circuits, adapted to the subdivision as presented in FIG. 4. Only one IMD (170) is used to monitor the insulation of all the frames from their neighbors. Monitoring is performed in two stages: firstly, frame (60) is used as a first frame to monitor the structure insulation of the overhead traveling crane (60) from the adjacent frames: the gantry tracks (110) and (120), both earthed and constituting a single frame, and the carriage (70); secondly, the carriage (70) is used as a first frame to monitor the structure insulation of the carriage (70) from its adjacent frames: the cabin (80) and all the tools (90). The relays chosen are single switch relays. Relays 270.1 and 270.2 are coupled.

Relays (271), (272) and (273) follow, according to the test to be carried out, the switching diagrams shown in table 1 below, where 0 means a contact on the left, 1 a contact on the right and X an indifferent position.

TABLE 1

| test | (270.1) and (270.2) | (271) | (272) | (273) |
|---|---|---|---|---|
| (60)/(110 and 120) | 0 | 0 | 1 | X |
| (60)/(70) | 0 | 0 | 0 | X |
| (70)/(80) | 1 | 1 | X | 0 |
| (70)7(90) | 1 | 1 | X | 1 |

All the frames (70, 110, 120, 80, 90), except the overhead traveling crane (60) which is always used as a first frame in this example, are connected to part of the second portion of the measuring circuit via a high voltage adapter plate (72, 112, 82, 92 respectively). Each part of the second portion of the measuring circuit is itself duplicated: a first series of cables connects a terminal (172) of the IMD (170) to a frame via one or more relays (cf. the switching diagrams above) and another series of cables connects all the HVPs to a stud (171.2) on the other IMD (170) terminal. The IMD is provided with a system for testing the intactness of the loops formed in this way.

1. A monitoring system for regularly monitoring the insulation of a frame which is separated from a plurality of adjacent frames and is isolated from each of said adjacent frames by an insulator level, characterized in that the monitoring system comprises:
a) a permanent insulation monitoring device;
b) a first portion of measuring circuit connecting said frame to a first terminal of said insulation monitoring device;
c) a second portion of measuring circuit used to connect a second terminal of said insulation monitoring device to each of said adjacent frames, said second portion of measuring circuit including at least one relay that can be switched in order to alternately connect electrically said insulation monitoring device to a portion of measuring circuit connected to each of said adjacent frames;
said insulation monitoring device being provided with a means used to inject a current into the measuring circuit formed by the switching of said at least one relay and to measure the resistance of said circuit.

2. A system according to claim 1 in which synchronization between switching the at least one relay and injecting the measurement current into the measurement circuit is managed by a controller.

3. A system according to claim 1, in which said first portion of measuring circuit and said second portion of measuring circuit have duplicated wiring and in which said insulation monitoring device, having at least one of the first and second terminals duplicated as two studs, is provided with a second system for testing the intactness of a loop connected to a first of said studs and also either to a second of said studs or to the other of the first and second terminals.

4. A system according to claim 1 in which said insulation monitoring device has an impedance greater than 1 MΩ, defined so that, even with an over-voltage of 2000 V between two frames, the current likely to pass through a human being coming into contact with the two frames simultaneously, is lower than a critical value.

5. A system according to claim 1 in which each said relay is a high voltage relay.

6. A system according to claim 1 in which said insulation monitoring device is associated with at least one voltage adapter plate.

7. A system according to claim 1 including, in order to regularly monitor the insulation of a frame separated from each of its adjacent frames by an insulator level, further comprising:
a) the insulation monitoring device having an impedance higher than 1 MΩ, and having at least the first terminal duplicated as two studs and being provided with a system for testing the intactness of a loop connected to one of the studs and to either the other of the studs or to the second terminal;
b) a first portion of a double measuring circuit connecting said frame to the studs of the first terminal of said insulation monitoring device, said first portion of the double circuit having at least one cable being connected to one of the studs of said first terminal;
c) a plurality of high voltage adapter plates, each high voltage adapter plate being connected to one of said adjacent frames;
d) a second portion of the double measuring circuit making it possible to connect the other second terminal of said insulation monitoring device to each of the adjacent frames, said second portion including at least one relay, which makes it possible to alternately connect electrically said insulation monitoring device to a portion of the measuring circuit connected to said adjacent frame, said second portion of measuring circuit being duplicated by wiring connecting said high voltage plates to one of the studs, in order to test the intactness of the loop made by the connection with the voltage adapter plate of the adjacent frame corresponding to the insulator level monitored and said wiring.

8. A system according to any of claim 1 in which said insulation monitoring device emits a signal indicating that, the measurement having been validated and completed, one or more switches can be turned to form a next measuring circuit.

9. A system according to claim 8 characterized in that the system further includes a controller which controls said one or more switches during reception of said signal emitted by the insulation monitoring device.

10. A system for regularly monitoring the insulation of a servicing unit used for working on a electrolytic cell, said servicing unit being subdivided into frames separated from each other by insulator levels, any frame likely to come into contact with the electrolytic bath or to accommodate staff having to be separated from the earth by at least two insulator levels, characterized in that the system comprises a set of monitoring systems according to claim 1 for regularly monitoring the insulation, each frame making up said servicing unit being used either as a first frame, or as an adjacent frame in at least one of said monitoring systems.

11. A system according to claim 10, characterized in that said first portions of the measuring circuit and said second portions of the measuring circuit are arranged so that only one insulation monitoring device is used to carry out all the insulation measurements.

12. A system according to claim 10 in which a voltage adapter plate is installed on each said adjacent frame.

13. A system according to claim 10 characterized in that the system enables regularly monitoring the insulation of power circuits at a level of each frame of the servicing unit.

14. A system according to claim 13 in which the measuring circuits are arranged so that only one insulation monitoring device is used to carry out regular monitoring of the insulation of the power circuits at the level of each frame.

15. A system according to claim 14 in which, to monitor the insulation of the power circuits on two frames with the same insulation monitoring device, each frame having a separation transformer supplying, via a power supply device, all of a plurality of receivers associated with said frame, said receivers being connected to said frame by means of a connection device to said frame, said insulation monitoring device is connected alternately, via two relays with synchronized switching, to a neutral of the transformer by means of a first portion of circuit including a first of said relays and also to said frame by means of a second portion of circuit including a second of said relays.

16. A system according to claim 14 in which, to monitor the power circuit insulation of each of said frames with the same insulation monitoring device, each frame having a separation transformer supplying, via a power supply device, all the receivers associated with said frame, said receivers being connected to said frame, said insulation monitoring device is connected, alternately via two relays with synchronized multiple switching, to a neutral of the transformer associated with said frame by means of a first portion of circuit including a first of said relays, and also to said frame by means of a second portion of circuit including a second of said relays

17. A system according to claim 15 in which said first and second portion of the measuring circuit have duplicated wiring and in which said insulation monitoring device, having each of the first and second terminals duplicated as two studs, is provided with a second system enabling testing the intactness of a loop connected to couples of the studs.

18. A process for monitoring the insulation of a frame which is separated from a plurality of adjacent frames and is isolated from each of said adjacent frames by an insulator level, characterized in that a monitoring system according to claim 1 is used for regularly monitoring the insulation of a frame from neighboring frames.

19. A process for monitoring the insulation of a servicing unit used for working on a electrolytic cell, said servicing unit being subdivided into frames separate from each other by insulator levels, any frame likely to come into contact with the electrolysis bath or to accommodate staff having to be separated from the earth by at least two insulator levels, characterized in that a system according to claim 10 is used for regularly monitoring the insulation of the servicing unit.
